(19) United States
(12) Patent Application Publication
(10) Pub. No.: US 2013/0083213 A1
(43) Pub. Date: Apr. 4, 2013

(54) IMAGE PROCESSING APPARATUS, CORRECTING METHOD, AND IMAGING APPARATUS

(71) Applicants: Masakazu KAWADA, Kanagawa (JP); Masashi NAKATA, Kanagawa (JP)

(72) Inventors: Masakazu KAWADA, Kanagawa (JP); Masashi NAKATA, Kanagawa (JP)

(73) Assignee: Sony Corporation, Tokyo (JP)

(21) Appl. No.: 13/609,688

(22) Filed: Sep. 11, 2012

(30) Foreign Application Priority Data
Sep. 30, 2011 (JP) 2011-216201

(51) Int. Cl. G06K 9/46; H04N 5/225

(52) U.S. Cl. 348/222.1; 382/165; 348/E05.024

(57) ABSTRACT

An image processing apparatus includes a calculation unit configured to calculate a parameter indicating a degree of change of a difference value between signal values of pixel signals of different pixels in an OPB region of an imaging element, and an estimation unit configured to estimate a reference value of a black level which is used for correcting a black level of a signal value of a pixel signal in an effective pixel region of the imaging element, by using a model of the parameter that is calculated by the calculation unit.

### BACKGROUND

The present technology relates to an image processing apparatus, a correcting method, and an imaging apparatus. In particular, the present technology relates to an image processing apparatus, a correcting method, and an imaging apparatus by which black level correction can be more accurately performed.

There is such method that when light leakage that light leaks into a light-shielding pixel region, which is provided as a region of pixels which is shielded from incident light from the outside, occurs, correction is performed by using the black level of the region, in related art (for example, refer to Japanese Unexamined Patent Application Publication No. 2008-048244). In the case of this method, when an imaging element is irradiated with light which is strong enough to cause light leakage in the whole of the light-shielding pixel region, a black level which is detected in the light-shielding pixel region so as to be a reference floats and therefore, it has been difficult to accurately perform black level correction.

Further, such method can be considered that a light-shielding pixel region is provided away from an effective pixel region so as to avoid an occurrence of light leakage in the whole of the light-shielding pixel region. However, a physical distance from the effective pixel region is increased, so that the number of lines is further increased. Accordingly, there has been such concern that a chip area and the cost may be increased.

Further, such method has been devised that a value of a black level which is preliminarily recorded is used in a case where it is determined that light leakage occurs in such light-shielding pixel region. In the case of this method, the black level which is preliminarily assumed is used, so that there has been such concern that the stored black level may differ from an actual black level when light leakage occurs under an unexpected condition in an actual operation. Therefore, it may have been difficult to accurately perform black level correction.

Apropos, such method has been devised that a ratio between dark signal current of an effective pixel region and dark current of a light-shielding pixel region is preliminarily stored and black level correction is performed by using the ratio (for example, refer to Japanese Patent No. 4462299 and Japanese Unexamined Patent Application Publication No. 2009-284424).

### SUMMARY

However, the methods disclosed in Japanese Patent No. 4462299 and Japanese Unexamined Patent Application Publication No. 2009-284424 are methods for accurately performing black level correction even in pixel regions having different dark current properties. Therefore, it may have been difficult to accurately perform black level correction with respect to light leakage. Similarly, it may have been difficult to accurately perform black level correction in a case where a color temperature of radiated light is changed, as well.

It is desirable to more accurately perform black level correction.

An image processing apparatus according to an embodiment of the present technology includes a calculation unit configured to calculate a parameter indicating a degree of change of a difference value between signal values of pixel signals of different pixels in an OPB region of an imaging element, and an estimation unit configured to estimate a reference value of a black level, which is used for correcting a black level of a signal value of a pixel signal in an effective pixel region of the imaging element, by using a model of the parameter that is calculated by the calculation unit.

The image processing apparatus may further include a storage unit configured to store the model of the parameter. In the image processing apparatus, the estimation unit may estimate the reference value of the black level by using the model that is stored in the storage unit.

The image processing apparatus may further include a generation unit configured to generate a model of the parameter. In the image processing apparatus, the storage unit may store the model of the parameter which is generated by the generation unit.

The generation unit may generate the parameter for every predetermined condition, and the storage unit may store the model, which is generated by the generation unit, of the parameter for the every condition.

The image processing apparatus may further include a specifying unit configured to specify a model closest to the parameter that is calculated by the calculation unit, from the model that is stored in the storage unit. In the image processing apparatus, the estimation unit may estimate a reference value of the black level by using the model that is specified by the specifying unit.

The image processing apparatus may further include a detection unit that compares a signal value of a pixel signal of the OPB region or a difference value between pixels, of which signal values are different from each other, with a threshold value so as to detect light leakage into the OPB region. In the image processing apparatus, the estimation unit may estimate a reference value of the black level only in a case where the light leakage is detected by the detection unit.

The image processing apparatus may further include a correction unit configured to correct a black level of a signal value of a pixel signal in the effective pixel region of the imaging element, by using the reference value of the black level which is estimated by the estimation unit.

The parameter may be a change rate or a change amount of the difference value for every distance to the effective pixel region.

The imaging element may have a multi-layer configuration, and the calculation unit and the estimation unit may be provided on a layer on which the OPB region and the effective pixel region are not formed, in the multi-layer configuration.

The imaging element may have a vertical light dispersion configuration by which a plurality of color signals are detected in each pixel, the calculation unit may calculate the parameter for each of the color signals, and the estimation unit may estimate a reference value of the black level for each of the color signals.

The imaging element may detect infrared light, the calculation unit may calculate a parameter indicating a degree of change of a difference value between signal values of pixel signals of infrared light of different pixels in the OPB region of the imaging element, and the estimation unit may estimate a reference value of a black level which is used for correcting a black level of a signal value of a pixel signal of infrared light of an effective pixel region of the imaging element, by using a model of the parameter that is calculated by the calculation unit.

A correcting method, according to another embodiment of the present technology, for correcting a black level of a signal value of a pixel signal in an effective pixel region of an imaging element includes calculating a parameter indicating a degree of change of a difference value between signal values of pixel signals of different pixels in an OPB region of the imaging element by a calculation unit, estimating a reference value of a black level which is used for correcting a black level of a signal value of a pixel signal in the effective pixel region by using a model of the calculated parameter by an estimation unit, and correcting a black level of a signal value of a pixel signal of the effective pixel region by using the estimated reference value of the black level, by a correction unit.

An imaging apparatus according to still another embodiment of the present technology includes an imaging element that includes an effective pixel region and an OPB region and images a subject, a calculation unit configured to calculate a parameter indicating a degree of change of a difference value between signal values of pixel signals of different pixels in the OPB region of the imaging element, and an estimation unit configured to estimate a reference value of a black level which is used for correcting a black level of a signal value of a pixel signal in the effective pixel region of the imaging element, by using a model of the parameter that is calculated by the calculation unit.

An image processing apparatus according to yet another embodiment of the present technology includes an acquisition unit configured to acquire signal values of a plurality of pixels of which periods of charge accumulation time in the OPB region of an imaging element are different from each other, and an estimation unit configured to estimate a reference value of a black level which is used for correcting a black level of a signal value of a pixel signal in an effective pixel region of the imaging element, by using the signal values, which are acquired by the acquisition unit, of the plurality of pixels of which the period of the charge accumulation time are different from each other.

The acquisition unit may acquire a signal value of a short time accumulation pixel of which the charge accumulation time in the OPB region is relatively short and a signal value of a long time accumulation pixel of which the charge accumulation time in the OPB region is relatively long, and the estimation unit may estimate a reference value of the black level by using the signal value, which is acquired by the acquisition unit, of the short time accumulation pixel and the signal value, which is acquired by the acquisition unit, of the long time accumulation pixel.

The estimation unit may estimate a reference value of the black level by using a rate between accumulation time of the short time accumulation pixel and accumulation time of the long time accumulation pixel, the signal value of the short time accumulation pixel, and the signal value of the long time accumulation pixel.

The image processing apparatus may further include a detection unit that compares the signal value that is acquired by the acquisition unit or a difference value between the signal values of pixels of which periods of the accumulation time in the OPB region are same as each other with a threshold value so as to detect light leakage into the OPB region. In the image processing apparatus, the estimation unit may estimate a reference value of the black level only in a case where the light leakage is detected by the detection unit.

The image processing apparatus may further include a correction unit configured to correct a black level of a signal value of a pixel signal in an effective pixel region of the imaging element, by using the reference value of the black level which is estimated by the estimation unit.

A correcting method, according to yet another embodiment of the present technology, for correcting a black level of a signal value of a pixel signal in an effective pixel region of an imaging element includes acquiring signal values of a plurality of pixels of which periods of charge accumulation time in the OPB region of the imaging element are different from each other by an acquisition unit, estimating a reference value of a black level which is used for correcting a black level of a signal value of a pixel signal in the effective pixel region, by using the acquired signal values of the plurality of pixels of which the periods of charge accumulation time are different from each other by an estimation unit, and correcting a black level of a signal value of a pixel signal in the effective pixel region by using the estimated reference value of the black level, by a correction unit.

An imaging apparatus according to yet another embodiment of the present technology includes an imaging element that includes an effective pixel region and an OPB region that are constituted of a plurality of pixels of which periods of charge accumulation time are different from each other, and images a subject, an acquisition unit configured to acquire signal values of the plurality of pixels of which the periods of charge accumulation time in the OPB region are different from each other, and an estimation unit configured to estimate a reference value of a black level which is used for correcting a black level of a signal value of a pixel signal of the effective pixel region, by using the signal values, which is acquired by the acquisition unit, of the plurality of pixels of which the periods of the charge accumulation time are different from each other.

According to an embodiment of the present technology, a parameter indicating a degree of change of a difference value between signal values of pixel signals of different pixels in an OPB region of an imaging element is calculated and a reference value of a black level for correcting a black level of a signal value of a pixel signal in an effective pixel region of the imaging element is estimated by using a model of the calculated parameter.

According to another embodiment of the present technology, a parameter indicating a degree of change of a difference value between signal values of pixel signals of different pixels in an OPB region of an imaging element is calculated, a reference value of a black level for correcting a black level of a signal value of a pixel signal in an effective pixel region is estimated by using a model of the calculated parameter, and a black level of a signal value of a pixel signal in the effective pixel region is corrected by using the estimated reference value of the black level.

According to still another embodiment of the present technology, a subject is imaged, a parameter indicating a degree of change of a difference value between signal values of pixel signals of different pixels in an OPB region of an imaging element is calculated, and a reference value of a black level for correcting a black level of a signal value of a pixel signal in an effective pixel region of the imaging element is estimated by using a model of the calculated parameter.

According to yet another embodiment of the present technology, signal values of a plurality of pixels of which periods of charge accumulation time in an OPB region of an imaging element are different from each other is acquired and a reference value of a black level for correcting a black level of a signal value of a pixel signal of an effective pixel region of the imaging element is estimated by using the acquired signal values of the plurality of pixels of which the periods of charge accumulation time are different from each other.

According to yet another embodiment of the present technology, signal values of a plurality of pixels of which periods of charge accumulation time in an OPB region of an imaging element are different from each other is acquired, a reference value of a black level for correcting a black level of a signal value of a pixel signal in an effective pixel region is estimated by using the acquired signal values of the plurality of pixels of which the periods of charge accumulation time are different from each other, and a black level of a signal value of a pixel signal in the effective pixel region is corrected by using the estimated reference value of the black level.

According to yet another embodiment of the present technology, a subject is imaged, signal values of a plurality of pixels of which periods of charge accumulation time in an OPB region are different from each other is acquired, and a reference value of a black level for correcting a black level of a signal value of a pixel signal in an effective pixel region is estimated by using the acquired signal values of the plurality of pixels of which the periods of charge accumulation time are different from each other.

According to the embodiments of the present technology, an image can be processed. Especially, black level correction can be more accurately performed.

### BRIEF DESCRIPTION OF THE DRAWINGS

FIG. 1 is a block diagram illustrating a main configuration example of an imaging apparatus according to an embodiment of the present technology;

FIG. 2 illustrates a state that a model is generated;

FIG. 3 illustrates an example of a signal value which is measured in model generation;

FIG. 4 illustrates an example of a signal value which is measured in model generation;

FIG. 5 illustrates an example of a change rate which is calculated in model generation;

FIG. 6 is a flowchart illustrating an example of a flow of model storage processing;

FIG. 7 illustrates an example of a state of estimation of a black level;

FIG. 8 illustrates an actually-measured signal value;

FIG. 9 illustrates an actually-measured signal value;

FIG. 10 is a flowchart illustrating an example of a flow of imaging processing;

FIG. 11 is a flowchart illustrating an example of a flow of black level setting processing;

FIG. 12 is a block diagram illustrating another configuration example of an imaging apparatus according to another embodiment of the present technology;

FIG. 13 illustrates an example of a state of black level estimation;

FIG. 14 is a flowchart illustrating an example of a flow of black level setting processing;

FIG. 15 illustrates the multi-layer configuration;

FIG. 16 illustrates the vertical light dispersion configuration;

FIG. 17 is a block diagram illustrating still another configuration example of an imaging apparatus according to still another embodiment of the present technology; and

FIG. 18 is a block diagram illustrating a main configuration example of a control unit.

### DETAILED DESCRIPTION OF EMBODIMENTS

Embodiments of the present technology (referred to below as embodiments) are described below. The description is given in the following order.

1. Embodiment (Imaging Apparatus)

2. Another Embodiment (Imaging Apparatus)

3. Still Another Embodiment (Imaging Apparatus)

### 1. Embodiment

### [Imaging Apparatus]

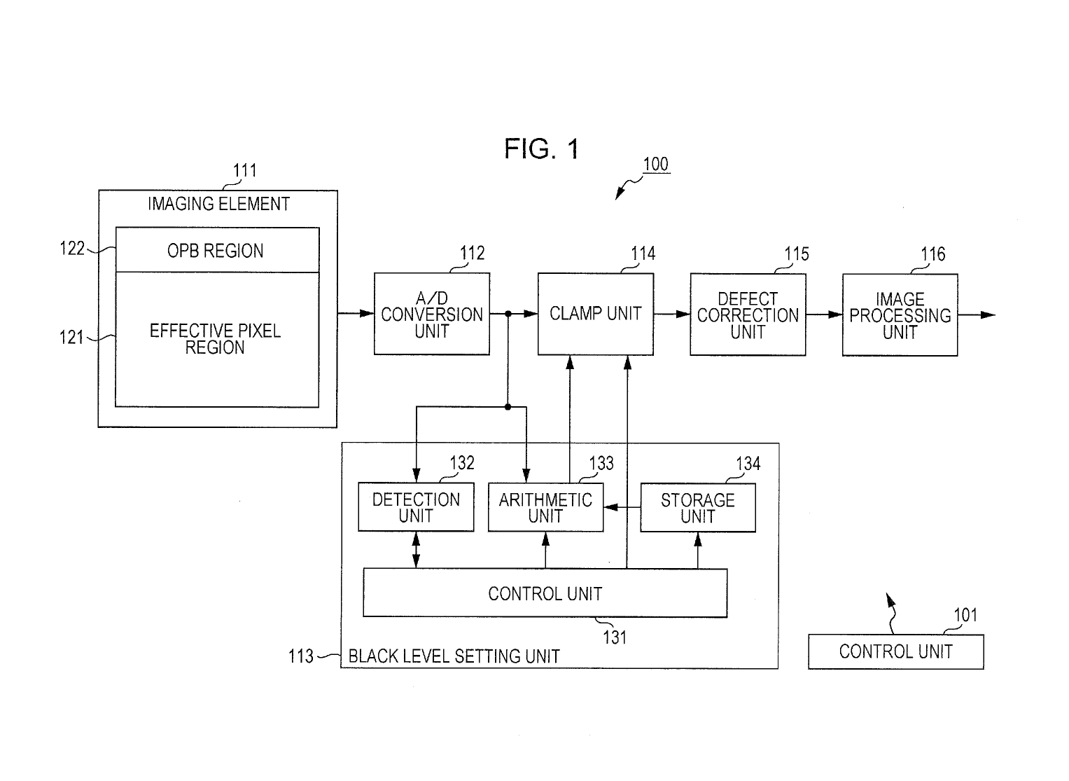

FIG. 1 is a block diagram illustrating a main configuration example of an imaging apparatus according to an embodiment of the present technology. An imaging apparatus 100 depicted in FIG. 1 images a subject so as to obtain picked-up image data.

As depicted in FIG. 1, the imaging apparatus 100 includes a control unit 101, an imaging element 111, an A/D conversion unit 112, a black level setting unit 113, a clamp unit 114, a defect correction unit 115, and an image processing unit 116.

The control unit 101 controls respective units of the imaging apparatus 100 so as to make respective units to perform processing related to imaging.

The imaging element 111 photoelectrically converts light incident from the outside so as to supply charges accumulated in each pixel to the A/D conversion unit 112 as a pixel signal. The imaging element 111 includes an effective pixel region 121 and an optical black (OPB) region 122 as regions which are constituted of respective pixels.

In a pixel in the effective pixel region 121, light incident on the pixel is photoelectrically converted by a photoelectric conversion element such as a photo diode, and the charge is read as a pixel signal. A pixel in the OPB region 122 basically has the same configuration as that in the effective pixel region 121, but the pixel in the OPB region 122 is shielded from light by a light-shielding film or the like. Thus, light is prevented from being incident on the pixel of the OPB region 122 from the outside. A signal value of a pixel signal of a pixel of the OPB region 122 is set as a reference of a black level and is used for such black level correction of a signal value of a pixel of the effective pixel region.

Here, in FIG. 1, the OPB region 122 is provided on an upper side of the effective pixel region 121 in the drawing in an adjacent manner. However, a position of the OPB region 122 is arbitrary as long as the OPB region 122 is positioned in the outside of the effective pixel region 121. For example, the OPB region 122 may be provided on a right side, a left side, or a lower side of the effective pixel region 121 in the drawing. Further, the OPB region 122 may be provided in a manner to surround the effective pixel region 121. Further, the OPB region 122 may not be adjacent to the effective pixel region 121. Furthermore, a plurality of OPB regions 122 may be provided. In addition, sizes and shapes of the OPB region 122 and the effective pixel region 121 are arbitrary.

The A/D conversion unit 112 converts signal values, which are outputted from the imaging element, of respective pixels of the effective pixel region 121 and the OPB region 122 into digital data (image data).

The black level setting unit 113 sets a black level which is to be used for black level correction performed in the clamp unit 114, on the basis of spatial change of the signal value of the OPB region 122. As depicted in FIG. 1, the black level setting unit 113 includes a control unit 131, a detection unit 132, an arithmetic unit 133, and a storage unit 134.

The clamp unit 114 performs correction of the black level with respect to the A/D-converted signal value of the pixel of the effective pixel region 121, by using the black level which is set by the black level setting unit 113. The defect correction unit 115 performs correction of a signal value of a defective pixel which is included in image data of which the black level is corrected. The image processing unit 116 performs arbitrary image processing such as white balance adjustment, with respect to the image data subject to the defect correction. The image processing unit 116 outputs the image data subject to the processing to the outside of the imaging apparatus 100.

In the imaging element 111, a property of photoelectric conversion is changed depending on external factors such as a temperature. Accordingly, even when same light is photoelectrically converted, outputted signal values may be different from each other due to such external factors. Therefore, the clamp unit 114 adjusts a black level of a signal value to a reference value so as to absorb such property change and make it possible to obtain a stable imaging result.

However, when the effective pixel region 121 is irradiated with exceedingly strong light, sneak of light may occur in the inside of the imaging element 111 and the light may leak into the OPB region 122. A signal value of the OPB region 122 floats due to such light leakage, so that it may have been difficult to accurately perform the black level correction of the signal value of the effective pixel region 121, in a correcting method of related art.

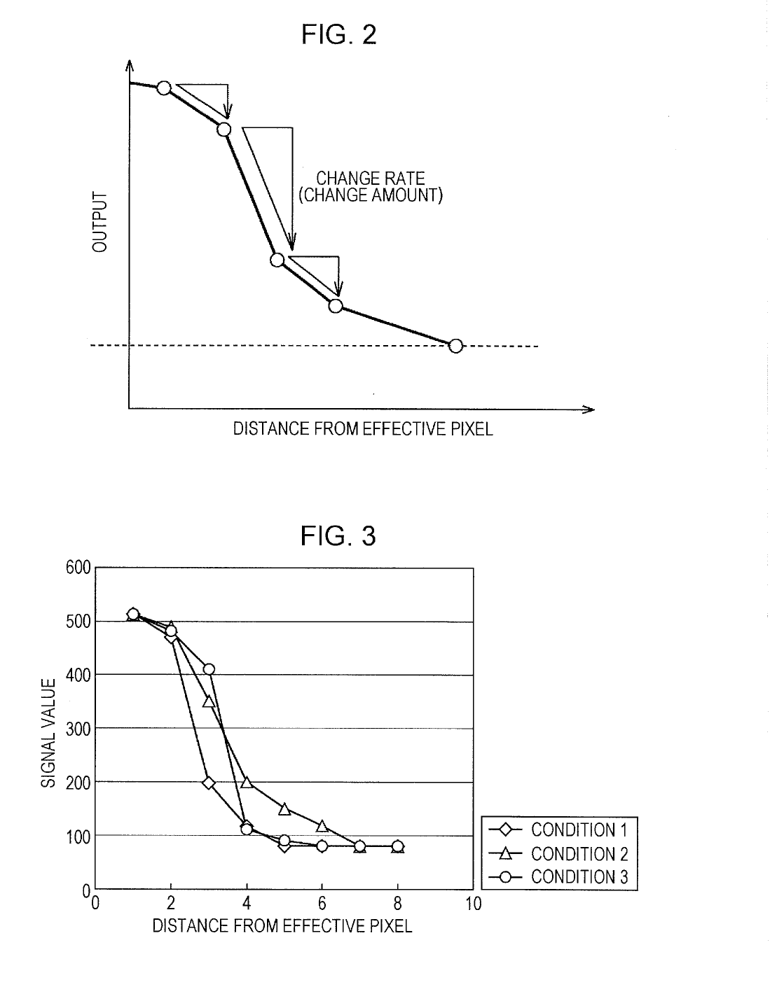

Apropos, when the effective pixel region 121 of the imaging element 111 is irradiated with strong light and the light leaks into the OPB region 122, the signal value of the OPB region 122 is decreased as the distance from the effective pixel region 121 is increased, as shown in a graph depicted in FIG. 2, for example. That is, a signal value of each pixel of OPB region 122 changes in accordance with the distance from the effective pixel region 121 (that is, a pixel position). Focusing on such spatial change of signal values, the black level setting unit 113 estimates a primary black level by using a difference value between signal values.

The black level setting unit 113 generates a model (FIG. 2), which represents spatial change of a signal value, of a change rate of a difference value between adjacent signal values before actual imaging to image a subject. Here, the change rate is generated as a parameter indicating a degree of change of a difference value. That is, the parameter generated here may be any parameter as long as the parameter indicates a degree of change of a difference value. For example, the parameter may be a change amount. Here, a parameter representing such degree of change of a difference value is referred to as a “change rate” in the following description. That is, unless it is specifically mentioned, the “change rate” mentioned below includes an arbitrary parameter representing a degree of change of a difference value, such as the “change amount”.

The detection unit 132 detects light leakage depending on whether a difference value of signal values of pixels adjacent to each other in the OPB region 122 in a direction separating from the effective pixel region 121 is larger than a threshold value which is preliminarily stored in a resistor or the like. That is, when a difference value is larger than the threshold value, the detection unit 132 determines that the detection unit 132 has detected light leakage and supplies the determination result to the control unit 131.

Here, such determination of detection of light leakage may be performed by using a signal value itself. That is, when the detection unit 132 compares a signal value with a prepared threshold value and the signal value is larger than the threshold value, it may be determined that the detection unit 132 has detected light leakage.

When the light leakage is detected, the control unit 131 controls the arithmetic unit 133 to make the arithmetic unit 133 to calculate a change rate of a difference value between signal values of pixels which are adjacent to each other in the direction separating from the effective pixel region 121 and generate a model.

More concretely, the arithmetic unit 133 calculates a difference value between signal values of pixels adjacent to each other in the OPB region in the direction separating from the effective pixel region 121 and calculates a change rate of the difference value for every distance to the effective pixel region 121.

The storage unit 134 is controlled by the control unit 131 and stores a signal value and a change rate for every distance to the effective pixel region as a model.

A difference value of signal values is compared with data stored in the storage unit so as to calculate a black level from data exhibiting the closest property.

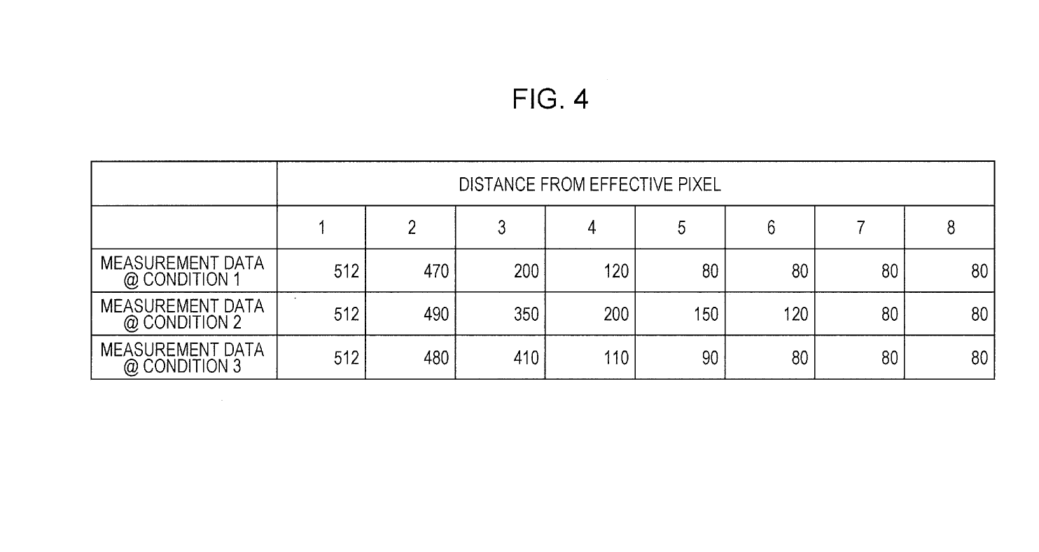

The black level setting unit 113 generates a plurality of such models under imaging conditions which are different from each other, so as to store the models. FIG. 3 illustrates signal values of the OPB region 122 under respective conditions. When such signal values are obtained, the storage unit 134 stores these signal values for respective conditions (respective models) for every distance to the effective pixel region 121 as depicted in FIG. 4.

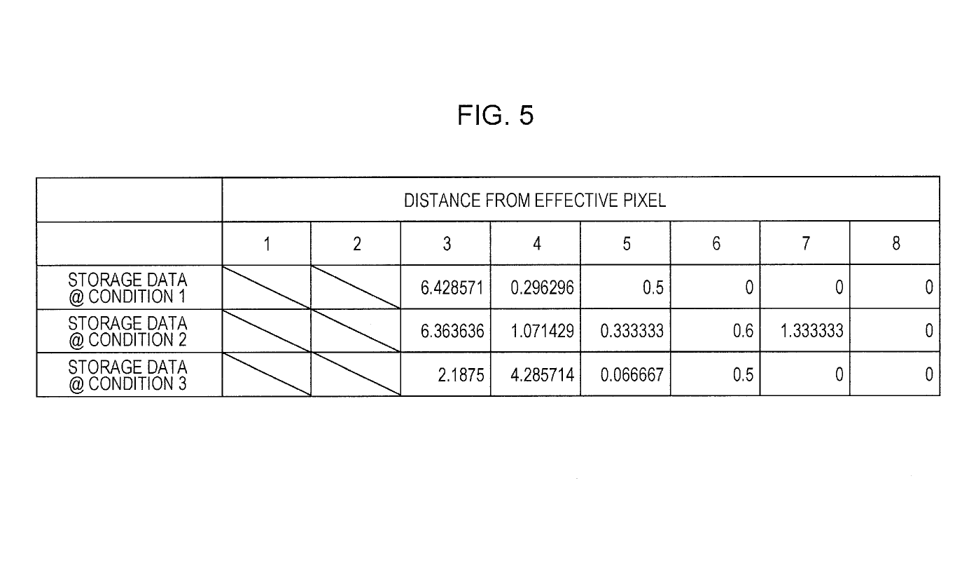

The arithmetic unit 133 calculates a change rate of a difference value from signal values as described above. The storage unit 134 stores the change rate for each condition (each model) for every distance to the effective pixel region 121 as depicted in FIG. 5.

Generation timing of such models is arbitrary as long as the timing is before actual imaging. For example, such model may be generated before factory shipment so as to be shipped out in a state that the model is stored in the storage unit 134.

Here, when such model is generated, the OPB region may be set larger than the actual imaging element 111 and transition of a signal value due to light leakage may be measured until the signal value settles into a certain value. Thus, a signal value is measured in the OPB region which is larger than the actual OPB region. Accordingly, even if light leakage occurs in the whole of the OPB region 122, the black level setting unit 113 can more accurately set a black level. Here, the black level setting unit 113 may calculate an anticipated value (a convergence value of a signal value) from acquired signal values and store the anticipated value.

Further, imaging conditions for generating a model are arbitrary. For example, a model may be generated for every color temperature. Further, a model may be generated for respective optical conditions such as setting of a diaphragm, presence/absence of an IR cut filter, a type of a lens, and an incident angle, for example.

The black level setting unit 113 can select a closer model in the black level correction, as described later, by generating a model under conditions closer to actual use, so that the clamp unit 114 can perform more accurate black level correction.

### [Flow of Model Storage Processing]

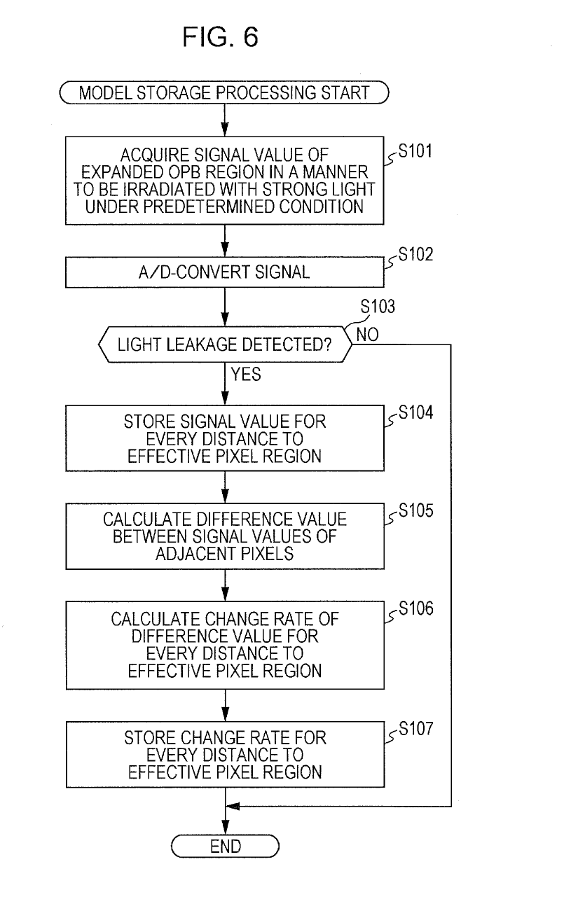

An example of a flow of such model storage processing is described with reference to a flowchart of FIG. 6.

When the model storage processing is started, the imaging element 111 acquires a signal value of an expanded OPB region in a manner to be irradiated with strong light under a predetermined condition in step S101.

In step S102, the A/D conversion unit 112 A/D-converts the signal value acquired in step S101.

In step S103, the detection unit 132 compares the signal value (or a difference value) with a threshold value so as to determine whether to have detected light leakage or not. When the signal value (or the difference value) is larger than the threshold value and it is determined that light leakage is detected, the control unit 131 advances the processing to step S104.

In step S104, the storage unit 134 stores a signal value for every distance to the effective pixel region 121 as shown in a table depicted in FIG. 4.

In step S105, the arithmetic unit 133 calculates a difference value between signal values of pixels which are adjacent to each other in a direction separating from the effective pixel region 121.

In step S106, the arithmetic unit 133 calculates a change rate of the difference value for every distance to the effective pixel region 121.

In step S107, the storage unit 134 stores the change rate calculated in step S106 for every distance to the effective pixel region 121 as shown in a table depicted in FIG. 5.

When the processing of step S107 is ended, the control unit 101 ends the model storage processing. Further, when the signal value (or the difference value) is equal to or less than the threshold value and it is determined that light leakage has not been detected in step S103, the control unit 131 ends the model storage processing.

The imaging apparatus 100 performs the above-described model storage processing for respective conditions so as to generate and store models of respective conditions.

### [Estimation of Black Level in Actual Imaging]

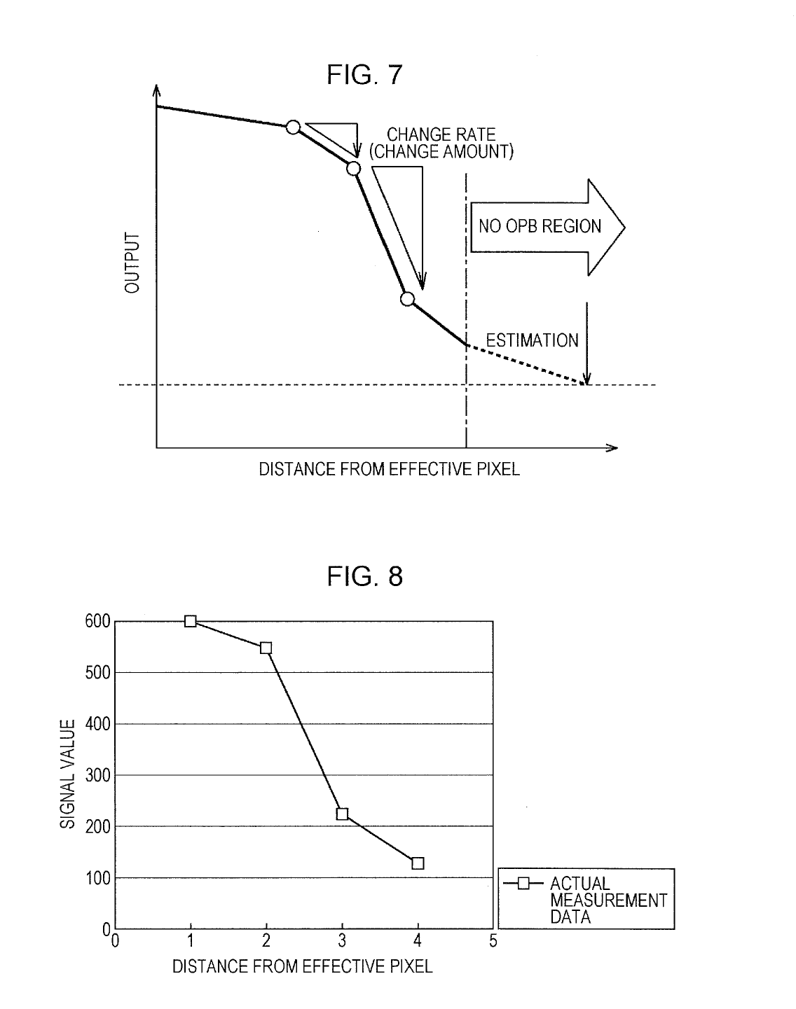

In actual imaging to image a subject, the arithmetic unit 133 calculates a change rate of a difference value from actually-obtained signal values, as depicted in a graph of FIG. 7, for example. Then, the arithmetic unit 133 compares the calculated change rate with a model (a change rate of the difference value) stored in the storage unit 134 and selects a model of which transition of a change rate is the closest. Subsequently, the arithmetic unit 133 estimates a reference value of a black level (also referred to below merely as a black level) which is used for correction (clamp processing) of a black level of a signal value of a pixel signal in the effective pixel region, by using the model.

As described above, a model is generated by using a signal value of an expanded OPB region which is larger than the actual OPB region 122 or estimating a convergence value of the signal value. Accordingly, even in a case where light leaks into the whole of the OPB region 122, for example, the arithmetic unit 133 can obtain a correct value of a black level (a convergence value of the signal value) by referring to the model, as depicted in FIG. 7.

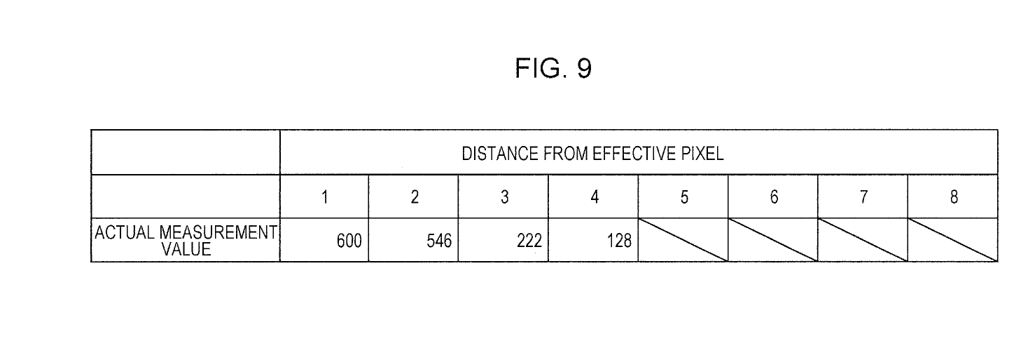

More specific example is described. For example, it is assumed that the storage unit 134 preliminarily stores data depicted in FIGS. 4 and 5 as models. Further, it is assumed that signal values shown in a graph of FIG. 8 and a table of FIG. 9 are acquired in the OPB region 122 in actual imaging.

When the detection unit 132 determines that light leakage is detected from these signal values, the arithmetic unit 133 calculates a difference value between signal values of pixels adjacent to each other. That is, in a case of the example of FIG. 9, a difference value in respective rows is calculated as the following.

row 1−row 2=600−546=54

row 2−row 3=546−222=324

row 3−row 4=222−128=94

Subsequently, the arithmetic unit 133 calculates a change rate of these calculated difference values, for every row as the following.

(row 2−row 3)/(row 1−row 2)=324/54=6.000

(row 3−row 4)/(row 2−row 3)=94/324=0.290

The arithmetic unit 133 compares the data (change rates) obtained as above with data of models stored in the storage unit 134 so as to select a model which is the closest to an actual measured value. In a case of the example of FIG. 5, data of the model of the condition 1 is the closest to the actual measured value. The errors are respectively 7.14% and 2.13%.

Here, in this comparison, the arithmetic unit 133 may determine that a value of the model is correct (approximate to the actual measured value) when the error is 10% or less, for example.

In data of an actual measurement example, data of pixels after the fourth pixel separating from the effective pixel region 121 does not exist. Further, in this fourth pixel, signal values are not converged. However, the data of the model stored in the storage unit 134 exists until the black level is converged (including an estimated value) as described above. Accordingly, the arithmetic unit 133 can obtain a more correct black level by referring to this model.

More specifically, in the case of the model of the condition 1 of FIG. 5, a value of (row 4−row 5) is decreased by 0.5 times of a value of (row 3−row 4). Accordingly, a difference value of (row 4−row 5) is calculated as the following.

(row 3−row 4)*storage data of 5 pixels@condition 1=94*0.5=47

That is, a signal value of the fifth pixel is lower by 47 than a signal value of the fourth pixel. Accordingly, the signal value of the fifth pixel is calculated as the following.

128−47=81

According to the table of FIG. 5, a change rate of (row 5−row 6) is 0. That is, a signal value “81” of the fifth pixel from the effective pixel region 121 is a convergence value (a correct black level) of the signal value. When the arithmetic unit 133 estimates the black level as above, the arithmetic unit 133 supplies the estimated value to the clamp unit 114 so as to allow the clamp unit 114 to use the estimated value as the black level for clamp processing.

That is, this estimated black level is used for correction of the black level of a signal value of the effective pixel region by the clamp unit 114. Accordingly, the clamp unit 114 can more accurately correct the black level.

### [Flow of Imaging Processing]

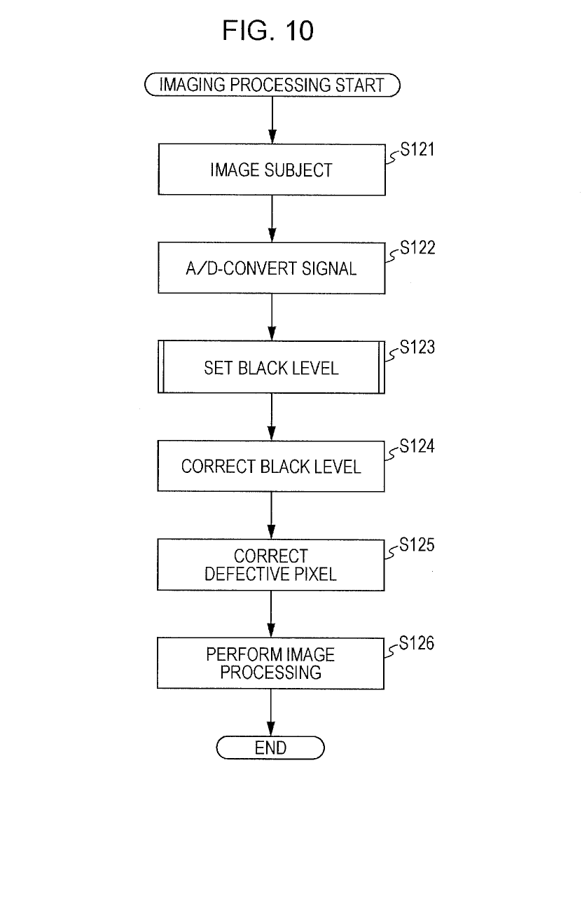

An example of a flow of imaging processing in actual imaging is described with reference to a flowchart of FIG. 10.

When the imaging processing is started, the imaging element 111 images a subject in step S121 and outputs signal values of respective pixels of the effective pixel region 121 and the OPB region 122. In step S122, the A/D conversion unit 112 A/D-converts the signal values obtained in the imaging of step S121.

In step S123, the black level setting unit 113 sets a black level as described above by using the signal value of the OPB region 122 which is obtained in the imaging of step S121.

In step S124, the clamp unit 114 corrects a black level of a signal value of each pixel of the effective pixel region 121 by using the black level set in step S123.

In step S125, the defect correction unit 115 corrects a signal value of a defective pixel.

In step S126, the image processing unit 116 performs image processing with respect to image data constituted of signal values of the effective pixel region 121 to which the black level correction and the defective pixel correction are performed.

When the processing of step S126 is ended, the control unit 101 ends the imaging processing.

### [Flow of Black Level Setting Processing]

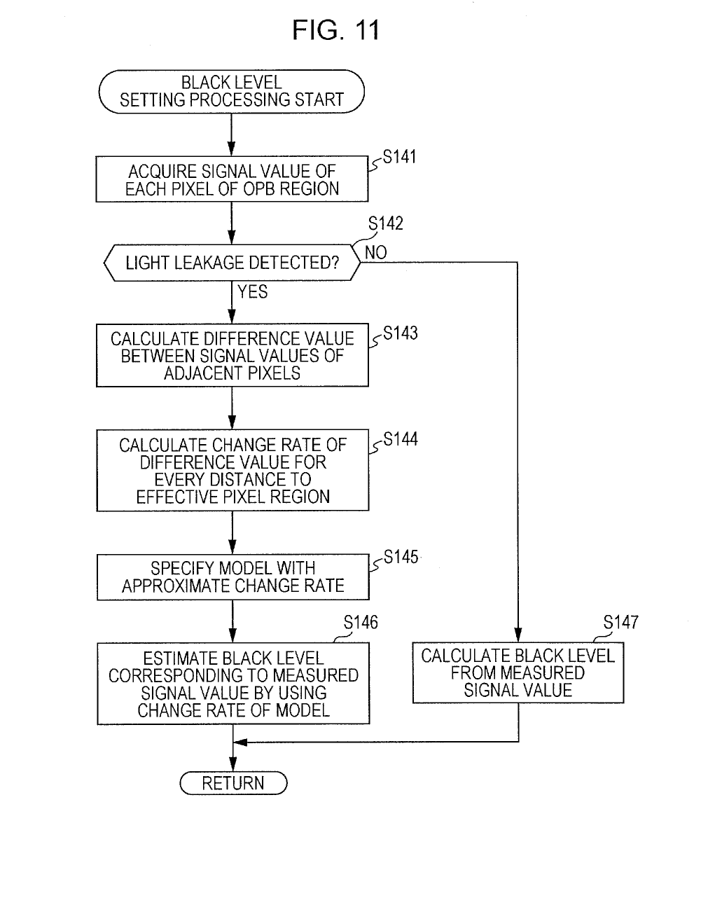

An example of a flow of the black level setting processing performed in step S123 of FIG. 10 is described with reference to a flowchart of FIG. 11.

When the black level setting processing is started, the detection unit 132 acquires a signal value of each pixel of the OPB region in step S141. In step S142, the detection unit 132 compares the signal value or a difference value with a threshold value so as to determine whether to have detected light leakage or not in accordance with the comparison result.

When the signal value (or the difference value) is larger than the threshold value and it is determined that light leakage has been detected, the control unit 131 advances the processing to step S143.

In step S143, the arithmetic unit 133 calculates a difference value between signal values of pixels which are adjacent to each other. Further, in step S144, the arithmetic unit 133 calculates a change rate of the difference value calculated in step S143 for every distance to the effective pixel region 121. In step S145, the arithmetic unit 133 refers to each model stored in the storage unit 134 and compares the calculated change rate with a change rate of the model so as to specify a model of which the change rate is the closest (select a model to be used).

In step S146, the arithmetic unit 133 estimates a more correct black level (a convergence value of the signal value (including an estimated value)) corresponding to an actually-measured signal value, by using the change rate of the selected model.

When the black level is estimated, the arithmetic unit 133 supplies the estimated value to the clamp unit 114 and ends the black level setting processing, returning the processing to FIG. 10.

Further, when the signal value (or the difference value) is equal to or lower than the threshold value and it is determined that light leakage has not been detected in step S142 of FIG. 11, the control unit 131 advances the processing to step S147. In step S147, the arithmetic unit 133 calculates a black level from an actually-measured signal value of the OPB region 122 without referring to the model. When the black level is calculated, the arithmetic unit 133 supplies the estimated value to the clamp unit 114 and ends the black level setting processing, returning the processing to FIG. 10.

The black level setting unit 113 can estimate a more correct black level by performing respective processing as above. Accordingly, the clamp unit 114 can more accurately perform the black level correction. That is, even when light leakage occurs in the OPB region 122, the imaging apparatus 100 can more accurately perform the black level correction. Namely, the imaging apparatus 100 can improve resistance properties of the black level correction with respect to light leakage.

Here, a change rate (or a change amount or the like) of a difference value between adjacent signal values is calculated as a parameter in the above description. However, any parameter may be employed as long as the parameter represents spatial change of a signal value (change of a signal value in accordance with a distance from the effective pixel region). Accordingly, any pixels, of the OPB region, for obtaining a difference value of signal values may be used as long as the pixels are arranged on different positions in a direction separating from the effective pixel region (the pixels do not have to be adjacent to each other).

### 2. Another Embodiment

### [Imaging Apparatus]

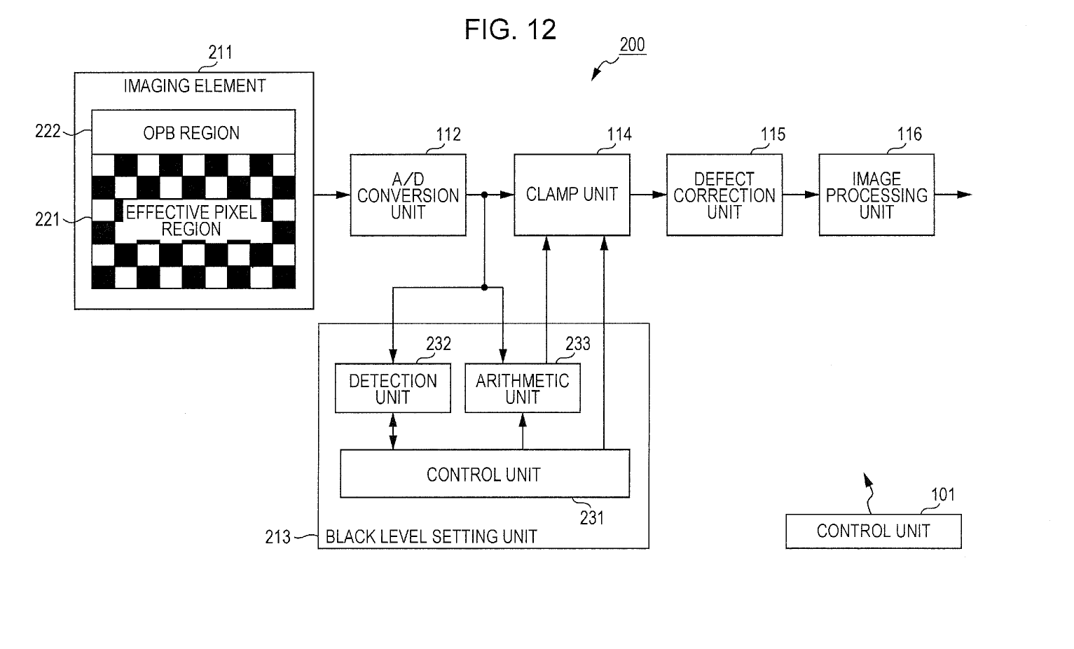

FIG. 12 is a block diagram illustrating another configuration example of an imaging apparatus according to another embodiment of the present technology. An imaging apparatus 200 depicted in FIG. 12 is basically the same apparatus as the imaging apparatus 100 of FIG. 1. That is, the imaging apparatus 200 basically has the same configuration and performs the same processing as the imaging apparatus 100. However, the imaging apparatus 200 includes an imaging element 211 instead of the imaging element 111 of the imaging apparatus 100.

In the imaging element 211, an OPB region 222 is provided in the outside of an effective pixel region 221, as is the case with the imaging element 111. However, the effective pixel region 221 is constituted of plural types of pixels of which periods of accumulation time of charges are different from each other, in order to obtain a high dynamic range image, for example. Such imaging element is disclosed in Japanese Unexamined Patent Application Publication No. 2010-213251, for example.

It is sufficient that the number of types of pixels (lengths of charge accumulation time) of the effective pixel region 221 is plural, and thus, the number of types may be two, or three or more. It is assumed that the effective pixel region 221 is constituted of two types of pixels which are a pixel of short accumulation time and a pixel of long accumulation time, for the sake of simplicity of the description below.

The OPB region 222 has the same configuration as that of the effective pixel region 221, as is the case with the OPB region 122, except for a point of being shielded from light. That is, the OPB region 222 is also constituted of two types of pixels which are a pixel of short accumulation time and a pixel of long accumulation time. The number of types of pixels of the OPB region 222 is same as that of the effective pixel region 221.

Further, the imaging apparatus 200 includes a black level setting unit 213 instead of the black level setting unit 113 of the imaging apparatus 100.

The black level setting unit 113 sets a more correct black level by using spatial change of a signal value (change rate of a difference value), while the black level setting unit 213 sets a more correct black level by using temporal change of a signal value (change rate of a difference value). That is, the black level setting unit 213 obtains a more correct black level by using difference between accumulation time of a pixel of short accumulation time and accumulation time of a pixel of long accumulation time.

More specifically, when a period of long accumulation time (long time accumulation) is a times as long as that of short accumulation time (short time accumulation), for example, output signal values of the both of the long accumulation time and the short accumulation time can be expressed by the following formulas.

Short time accumulation: 1x+black level=y(output value)

Long time accumulation: αx+black level=y′(output value)

x: Amount of light transmission in short time accumulation

y, y′: Signal value of light-shielding pixel region

α: Rate of accumulation time of long time accumulating pixel with respect to short time accumulating pixel

Since charge accumulation time of each pixel is given, a value of α is given. Further, output values y, y′ of respective short time accumulating pixel and long time accumulating pixel can be measured. Accordingly, a black level can be obtained from the both formulas.

That is, the black level setting unit 213 can obtain a black level without using a model. Namely, the black level setting unit 213 does not have to preliminarily generate and store a model.

Accordingly, as depicted in FIG. 12, the black level setting unit 213 includes a control unit 231, a detection unit 232, and an arithmetic unit 233, but does not include a storage unit.

The control unit 231 controls the detection unit 232 and the arithmetic unit 233. The detection unit 232 detects light leakage as is the case with the detection unit 132 and the arithmetic unit 233 detects a more correct black level.

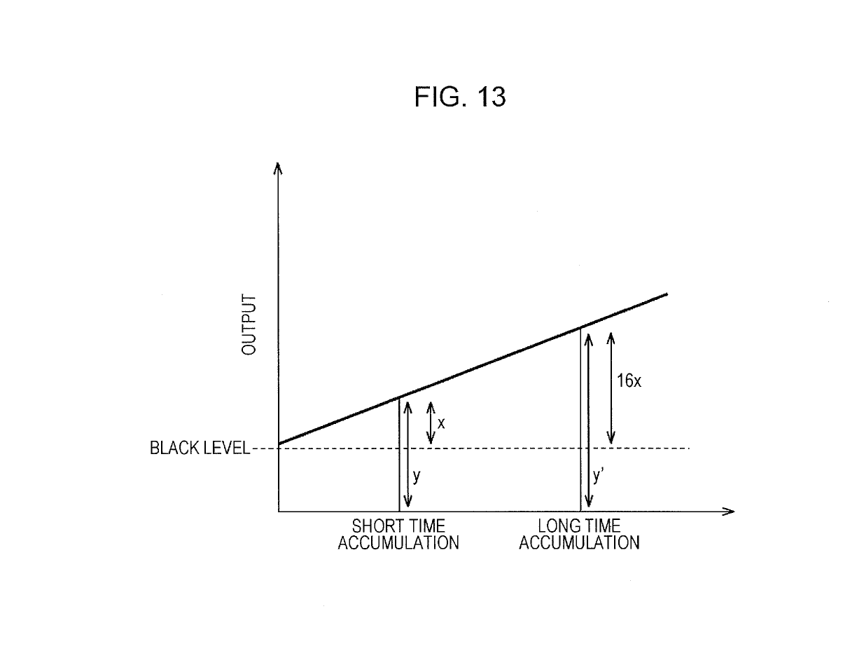

In a case where an effective pixel is irradiated with strong light and the light leaks into the OPB region, a signal value is increased as accumulation time is increased in a pixel in the OPB region into which the light leaks, as depicted in FIG. 13, for example. Difference between an accumulation amount of a pixel with short charge accumulation time and an accumulation amount of a pixel with long charge accumulation time is caused by the leaking light. That is, a more correct black level can be estimated from difference between signal values of pixels with different accumulation time, as depicted in FIG. 13.

When it is assumed that the time of long time accumulation is 16 times as long as the time of short time accumulation, for example, output signal values of the both time can be expressed as the following.

Short time accumulation: y(output value)=1x+black level

Long time accumulation: y′(output value)=16x+black level

x: Signal value generated due to light leakage in short time accumulation

y, y′: Signal value of OPB pixel region

Since output values y, y′ of respective short time accumulation pixel and long time accumulation pixel can be measured, a black level can be obtained from the both formulas. That is, when the above-mentioned formulas are newly rewritten, the following formula is obtained.

Black level=(16y−y′)/15

Accordingly, the arithmetic unit 233 can estimate a black level by measuring output values y, y′ of respective short time accumulation pixel and long time accumulation pixel.

For example, when y=96 and y′=576, black level=(16*96−576)/15=64. Further, when short time accumulation is 16.66 msec, long time accumulation is 66.66 msec, y=96, and y′=192, α is 4 and black level=(4*96−192)/(4−1)=64.

When the arithmetic unit 233 estimates a black level as described above, the arithmetic unit 233 supplies the estimated value to the clamp unit 114 so as to allow the clamp unit 114 to use the estimated value as a black level for clamp processing.

That is, the estimated black level is used for black level correction of a signal value of the effective pixel region by the clamp unit 114. Accordingly, the clamp unit 114 can more accurately perform black level correction.

### [Flow of Black Level Setting Processing]

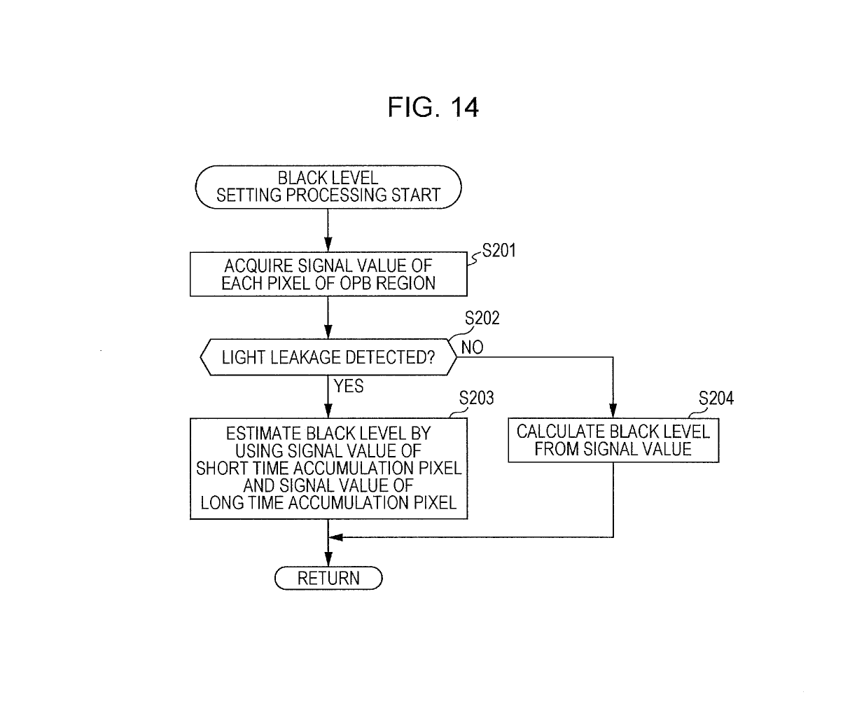

In a case of the imaging apparatus 200 as well, the imaging processing is performed as is the case in the embodiment described above. An example of a flow of the black level setting processing which is performed in step S123 of FIG. 10 is described with reference to a flowchart of FIG. 14.

When the black level setting processing is started, the detection unit 232 acquires a signal value of each pixel of the OPB region in step S201. In step S202, the detection unit 232 compares the signal value or a difference value with a threshold value so as to determine whether to have detected light leakage or not in accordance with the comparison result.

When the signal value (or the difference value) is larger than the threshold value and it is determined that light leakage has been detected, the control unit 231 advances the processing to step S203.

In step S203, the arithmetic unit 233 estimates a black level by using a signal value of a short time accumulation pixel and a signal value of a long time accumulation pixel. When the black level is estimated, the arithmetic unit 233 supplies the estimated value to the clamp unit 114 and ends the black level setting processing, returning the processing to FIG. 10.

Further, when the signal value (or the difference value) is equal to or lower than the threshold value and it is determined that light leakage has not been detected in step S202 of FIG. 14, the control unit 231 advances the processing to step S204. In step S204, the arithmetic unit 233 calculates a black level from an actually-measured signal value of the OPB region 222 without referring to a model. When the black level is calculated, the arithmetic unit 233 supplies the estimated value to the clamp unit 114 and ends the black level setting processing, returning the processing to FIG. 10.

The black level setting unit 213 can estimate a more correct black level by performing respective processing as above. Accordingly, the clamp unit 114 can more accurately perform the black level correction. That is, even when light leakage occurs in the OPB region 222, the imaging apparatus 200 can more accurately perform the black level correction. Namely, the imaging apparatus 200 can improve resistance properties of the black level correction with respect to light leakage.

### [Multi-Layer Configuration]

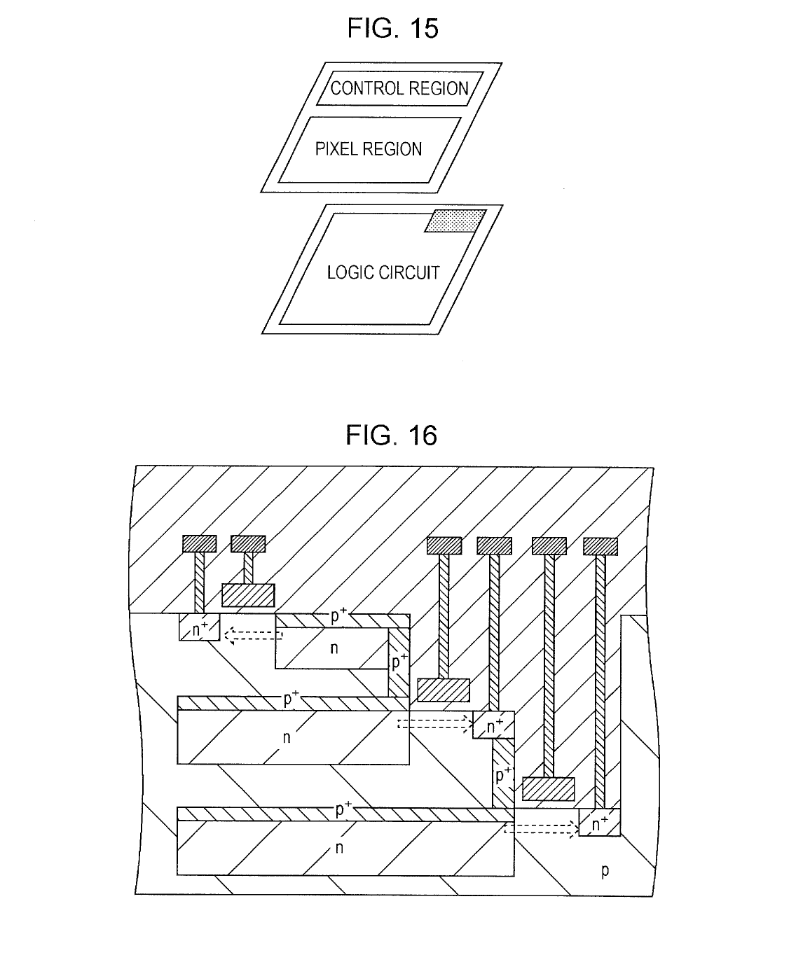

The imaging element may have the multi-layer configuration in which pixel regions (the effective pixel region and the OPB region), and a control circuit, a logic circuit, or the like other than the pixel regions are separately provided on separate layers as depicted in FIG. 15, for example. In a case where the imaging element 111 and the imaging element 211 have such multi-layer configuration, increase of a chip area can be suppressed by providing the black level setting unit 113 and the black level setting unit 213 on a layer different from a layer on which pixel regions are formed (for example, a layer on which a logic circuit is formed), as depicted in FIG. 15, for example.

### [Imaging Element]

The arrangement configuration of pixels of the imaging element 111 and the imaging element 211 are arbitrary. Further, the imaging element 111 and the imaging element 211 may be CCD image sensors, CMOS image sensors, or imaging elements in types other than these sensors. Further, the imaging element 111 and the imaging element 211 may be image sensors having the front side illumination type configuration or image sensors having the back side illumination type configuration.

That is, the embodiments of the present technology can be applied to an image signal obtained by any imaging element as long as the imaging element has an effective pixel region and an OPB region.

### [Vertical Light Dispersion Configuration]

The embodiments of the present technology can be also applied to a pixel signal which is obtained in an imaging element of the vertical light dispersion configuration which senses a plurality of color signals in one pixel, as the disclosure in Japanese Unexamined Patent Application Publication No. 2011-29453, for example.

For example, an imaging element of the vertical light dispersion configuration depicted in FIG. 16 senses three color signals R, G, and B in one pixel. In a case of this imaging element, amounts of signals generated due to light leakage are different among respective colors. Therefore, the black level setting unit 113 generates and prepares a model for each color. Accordingly, the black level setting unit 113 can correctly estimate a black level for each color. Further, the black level setting unit 113 compares and examines estimated black levels of respective colors, being able to set a more correct black level. That is, the clamp unit 114 can more accurately perform the black level correction.

### [Infrared Light]

A signal value for correcting a black level is not limited to a signal value of visible light. The embodiments of the present technology can be easily applied to an imaging apparatus which performs imaging by using infrared rays, as well. For example, an imaging apparatus which can perform imaging during nighttime as well performs imaging by using light such as infrared rays. However, a wavelength of infrared rays is long, so that there is high possibility that the light leaks into the OPB region.

The black level setting unit 113 can correct a black level of signal values of not only visible light but also any light in a similar fashion. That is, in a case where the black level of a signal value of infrared light is corrected, it is sufficient that the black level setting unit 113 preliminarily generates a model of infrared light and stores the model in the storage unit 134.

Namely, the imaging apparatus 100 can perform black level correction more accurately in the case of infrared light as well.

### 3. Still Another Embodiment

### [Imaging Apparatus]

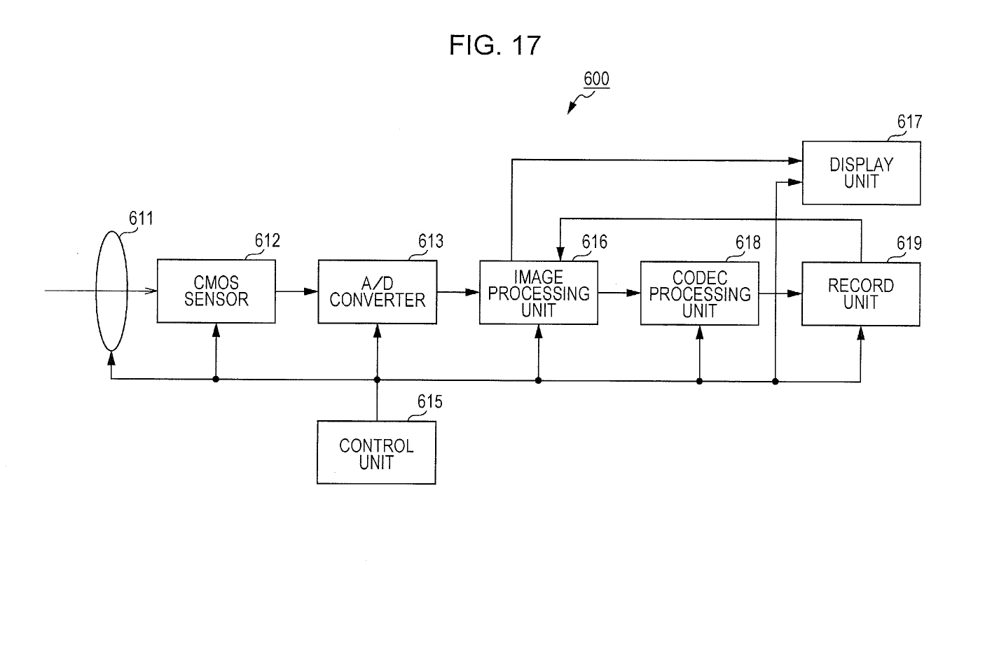

FIG. 17 illustrates a configuration example of an imaging apparatus according to still another embodiment of the present technology. An imaging apparatus 600 depicted in FIG. 17 images a subject and outputs an image of the subject as an electric signal.

As depicted in FIG. 17, the imaging apparatus 600 includes an optical unit 611, a CMOS sensor 612, an A/D converter 613, a control unit 615, an image processing unit 616, a display unit 617, a codec processing unit 618, and a record unit 619.

The optical unit 611 is composed of a lens which adjusts a focus to a subject and condenses light from a focused position, a diaphragm which adjusts exposure, a shutter which controls timing of imaging, and the like. The optical unit 611 transmits light (incident light) from the subject and supplies the light to the CMOS sensor 612.

The CMOS sensor 612 is an imaging element having the configuration which is described in the embodiment described first and the embodiment described second (the imaging element 111 or the imaging element 211). The CMOS sensor 612 photoelectrically converts incident light in an effective pixel region and supplies a signal for each pixel (a pixel signal) to the A/D converter 613. Further, the CMOS sensor 612 supplies a pixel signal of the OPB region to the A/D converter 613 as well. That is, the CMOS sensor 612 corresponds to the imaging element 111 of the imaging apparatus 100 or the imaging element 211 of the imaging apparatus 200.

The A/D converter 613 converts a pixel signal supplied at predetermined timing from the CMOS sensor 612 into digital data (image data) and sequentially supplies the digital data to the image processing unit 616 at predetermined timing.

The control unit 615 controls driving of the optical unit 611, the CMOS sensor 612, the A/D converter 613, the image processing unit 616, the display unit 617, the codec processing unit 618, and the record unit 619 on the basis of operation input or the like performed by a user, so as to allow respective units to perform processing related to the imaging.

The image processing unit 616 performs clamp processing (black level correction) with respect to the image data supplied from the A/D converter 613 as described in the embodiment described first and the embodiment described second.

Further, the image processing unit 616 can perform arbitrary image processing other than the clamp processing. For example, the image processing unit 616 may perform color mixture correction, white balance adjustment, de-mosaic processing, matrix processing, gamma correction, YC conversion, and the like.

That is, the image processing unit 616 corresponds to respective units which are the black level setting unit 113, the clamp unit 114, the defect correction unit 115, and the image processing unit 116 of the imaging apparatus 100 or the black level setting unit 213, the clamp unit 114, the defect correction unit 115, and the image processing unit 116 of the imaging apparatus 200.

The image processing unit 616 supplies the image data subject to the image processing to the display unit 617 and the codec processing unit 618.

The display unit 617 is provided as a liquid crystal display, for example, and displays an image of a subject on the basis of the image data supplied from the image processing unit 616.

The codec processing unit 618 performs encoding processing of a predetermined method with respect to the image data supplied from the image processing unit 616 and supplies the obtained coded data to the record unit 619.

The record unit 619 records the coded data received from the codec processing unit 618. The coded data recorded in the record unit 619 is read by the image processing unit 616 as necessary so as to be decoded. The image data obtained by the decoding processing is supplied to the display unit 617 and a corresponding image is displayed.

As described above, the imaging apparatus 600 estimates a black level by the method according to the embodiments of the present technology, so that the imaging apparatus 600 can more accurately perform black level correction and can improve image quality of a picked-up image which is obtained by imaging.

Here, the imaging apparatus including the imaging element of the embodiments of the present technology does not limitedly have the above-described configuration but may have other configuration.

Each of the apparatuses described above may include the configuration other than the configuration described above, of course. Further, each of the apparatuses is not limitedly configured as one apparatus but may be configured as a system constituted of a plurality of apparatuses.

### [Control Unit]

The series of the processing described above may be performed either by hardware or software. In a case where the series of processing is performed by software, a program constituting the software is installed on a computer. Here, examples of the computer include a computer incorporated in dedicated hardware, a general-purpose personal computer which is capable of performing various functions when various programs are installed thereon, the control unit 101 of FIGS. 1 and 12, the control unit 615 of FIG. 17, and the like.

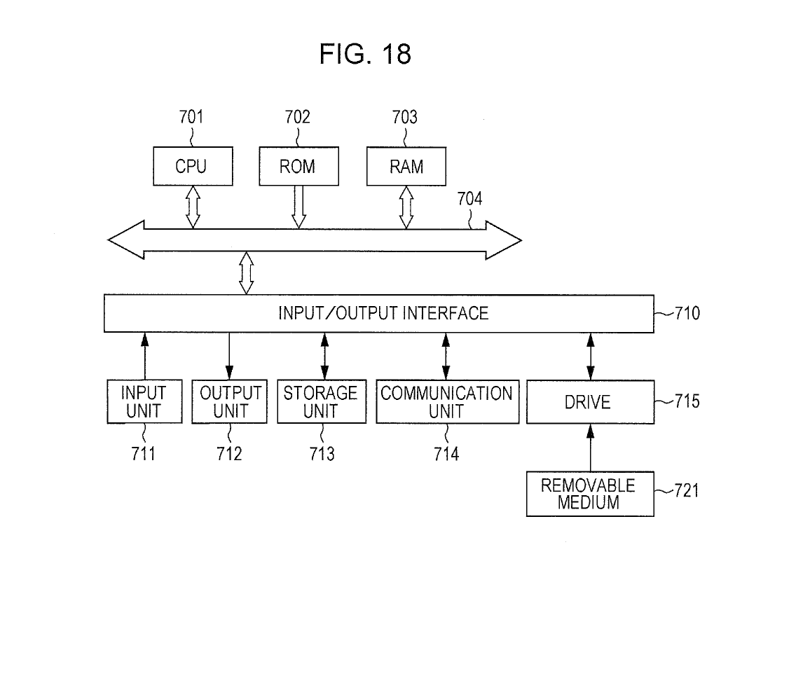

FIG. 18 is a block diagram illustrating a main configuration example of the control unit 615 of FIG. 17. The configuration illustrated in FIG. 18 is applicable to the control unit 101 of FIGS. 1 and 12 as well.

In FIG. 18, a central processing unit (CPU) 701 of the control unit 615 executes various processing in accordance with a program stored in a read only memory (ROM) 702 or a program loaded on a random access memory (RAM) 703 from a storage unit 713. In the RAM 703, data which is used for executing various processing by the CPU 701 and the like are also stored.

The CPU 701, the ROM 702, and the RAM 703 are mutually coupled via a bus 704. To this bus 704, an input/output interface 710 is also connected.

To the input/output interface 710, an input unit 711 composed of a keyboard, a mouse, and the like, a display composed of a cathode ray tube (CRT) or a liquid crystal display (LCD), an output unit 712 composed of a speaker and the like, the storage unit 713 composed of hard disk and the like, and a communication unit 714 composed of a modem and the like are connected. The communication unit 714 performs communication processing via a network including Internet.

To the input/output interface 710, a drive 715 is connected as necessary. Further, a removable medium 721 such as a magnetic disk, an optical disk, a magnetic-optical disk, and a semiconductor memory is arbitrarily attached to the input/output interface 710 and computer programs read from these media are installed on the storage unit 713 as necessary.

In a case where the above-described series of processing is performed by software, a program constituting the software is installed from a network or a storage medium.

This recoding medium is composed not only of the removable medium 721 which are distributed for delivering programs to a user separately from the apparatus main body but also of hard disk included in the ROM 702 in which a program, which is delivered to a user in a manner to be preliminarily incorporated in the apparatus main body, is recorded and the storage unit 713 as depicted in FIG. 18. The removable medium 721 is composed of a magnetic disc (including a flexible disc), an optical disc (including a compact disc-read only memory (CD-ROM), and a digital versatile disc (DVD)), a magneto-optical disk (including a mini disk (MD)), a semiconductor memory, or the like, in which a program is recorded.

Here, the program executed by the computer may be a program by which processing is performed in time series along the order mentioned in this specification or a program by which processing is performed in parallel or at necessary timing such as reception of calling.

A process of describing a program which is recorded in the recording medium includes not only processing performed in time series along the mentioned order but also processing which is not necessarily processed in time series but processed in parallel or individually, in this specification.

Further, in this specification, the system represents the whole apparatus composed of a plurality of devices (apparatuses).

Further, in the above description, the configuration described as one apparatus (or one processing unit) may be divided so as to be configured as a plurality of apparatuses (or processing units). Contrarily, the configuration described as a plurality of apparatuses (or processing units) in the above description may be collectively configured to be one apparatus (or one processing unit). Further, the configuration other than the above-mentioned configuration may be added to the configuration of each apparatus (or each processing unit). Further, as long as the configuration and operations of the whole system are substantially same, part of the configuration of a certain apparatus (or a certain processing unit) may be included in the configuration of other apparatus (or other processing unit). That is, embodiments of the present technology are not limited to the above-mentioned embodiments and various alterations may occur within the scope of the present technology.

The embodiments of the present technology may employ the following configuration as well.

(1) An image processing apparatus includes a calculation unit configured to calculate a parameter indicating a degree of change of a difference value between signal values of pixel signals of different pixels in an OPB region of an imaging element, and an estimation unit configured to estimate a reference value of a black level which is used for correcting a black level of a signal value of a pixel signal in an effective pixel region of the imaging element, by using a model of the parameter that is calculated by the calculation unit.

(2) The image processing apparatus according to (1) further includes a storage unit configured to store the model of the parameter. In the image processing apparatus, the estimation unit estimates the reference value of the black level by using the model that is stored in the storage unit.

(3) The image processing apparatus according to (2) further includes a generation unit configured to generate a model of the parameter. In the image processing apparatus, the storage unit stores the model of the parameter which is generated by the generation unit.

(4) In the image processing apparatus according to (3), the generation unit generates the parameter for every predetermined condition, and the storage unit stores the model, which is generated by the generation unit, of the parameter for the every condition.

(5) The image processing apparatus according to any one of (2) to (4) further includes a specifying unit configured to specify a model closest to the parameter that is calculated by the calculation unit, from the model that is stored in the storage unit. In the image processing apparatus, the estimation unit estimates a reference value of the black level by using the model that is specified by the specifying unit.

(6) The image processing apparatus according to any one of (1) to (5) further includes a detection unit that compares a signal value of a pixel signal of the OPB region or a difference value between pixels, of which signal values are different from each other, with a threshold value so as to detect light leakage into the OPB region. In the image processing apparatus, the estimation unit estimates a reference value of the black level only in a case where the light leakage is detected by the detection unit.

(7) The image processing apparatus according to any one of (1) to (6) further includes a correction unit configured to correct a black level of a signal value of a pixel signal in the effective pixel region of the imaging element, by using the reference value of the black level which is estimated by the estimation unit.

(8) In the image processing apparatus according to any one of (1) to (7), the parameter is a change rate or a change amount of the difference value for every distance to the effective pixel region.

(9) In the image processing apparatus according to any one of (1) to (8), the imaging element has a multi-layer configuration, and the calculation unit and the estimation unit are provided on a layer on which the OPB region and the effective pixel region are not formed, in the multi-layer configuration.

(10) In the image processing apparatus according to any one of (1) to (9), the imaging element has a vertical light dispersion configuration by which a plurality of color signals are detected in each pixel, the calculation unit calculates the parameter for each of the color signals, and the estimation unit estimates a reference value of the black level for each of the color signals.

(11) In the image processing apparatus according to any one of (1) to (10), the imaging element detects infrared light, the calculation unit calculates a parameter indicating a degree of change of a difference value between signal values of pixel signals of infrared light of different pixels in the OPB region of the imaging element, and the estimation unit estimates a reference value of a black level which is used for correcting a black level of a signal value of a pixel signal of infrared light in an effective pixel region of the imaging element, by using a model of the parameter that is calculated by the calculation unit.

(12) A correcting method for correcting a black level of a signal value of a pixel signal in an effective pixel region of an imaging element includes calculating a parameter indicating a degree of change of a difference value between signal values of pixel signals of different pixels in an OPB region of the imaging element by a calculation unit, estimating a reference value of a black level which is used for correcting a black level of a signal value of a pixel signal in the effective pixel region by using a model of the calculated parameter by an estimation unit, and correcting a black level of a signal value of a pixel signal of the effective pixel region by using the estimated reference value of the black level, by a correction unit.

(13) An imaging apparatus includes an imaging element that includes an effective pixel region and an OPB region and images a subject, a calculation unit configured to calculate a parameter indicating a degree of change of a difference value between signal values of pixel signals of different pixels in the OPB region of the imaging element, and an estimation unit configured to estimate a reference value of a black level which is used for correcting a black level of a signal value of a pixel signal in the effective pixel region of the imaging element, by using a model of the parameter that is calculated by the calculation unit.

(14) An image processing apparatus includes an acquisition unit configured to acquire signal values of a plurality of pixels of which periods of charge accumulation time in the OPB region of an imaging element are different from each other, and an estimation unit configured to estimate a reference value of a black level which is used for correcting a black level of a signal value of a pixel signal in an effective pixel region of the imaging element, by using the signal values, which are acquired by the acquisition unit, of the plurality of pixels of which the period of the charge accumulation time are different from each other.

(15) In the image processing apparatus according to (14), the acquisition unit acquires a signal value of a short time accumulation pixel of which the charge accumulation time in the OPB region is relatively short and a signal value of a long time accumulation pixel of which the charge accumulation time in the OPB region is relatively long, and the estimation unit estimates a reference value of the black level by using the signal value, which is acquired by the acquisition unit, of the short time accumulation pixel and the signal value, which is acquired by the acquisition unit, of the long time accumulation pixel.

(16) In the image processing apparatus according to (15), the estimation unit estimates a reference value of the black level by using a rate between accumulation time of the short time accumulation pixel and accumulation time of the long time accumulation pixel, the signal value of the short time accumulation pixel, and the signal value of the long time accumulation pixel.

(17) The image processing apparatus according to any one of (14) to (16) further includes a detection unit that compares the signal value that is acquired by the acquisition unit or a difference value between the signal values of pixels of which periods of the accumulation time in the OPB region are same as each other with a threshold value so as to detect light leakage into the OPB region. In the image processing apparatus, the estimation unit estimates a reference value of the black level only in a case where the light leakage is detected by the detection unit.

(18) The image processing apparatus according to any one of (14) to (17) further includes a correction unit configured to correct a black level of a signal value of a pixel signal in an effective pixel region of the imaging element, by using the reference value of the black level which is estimated by the estimation unit.

(19) A correcting method for correcting a black level of a signal value of a pixel signal in an effective pixel region of an imaging element includes acquiring signal values of a plurality of pixels of which periods of charge accumulation time in the OPB region of the imaging element are different from each other by an acquisition unit, estimating a reference value of a black level which is used for correcting a black level of a signal value of a pixel signal in the effective pixel region, by using the acquired signal values of the plurality of pixels of which the periods of charge accumulation time are different from each other by an estimation unit, and correcting a black level of a signal value of a pixel signal in the effective pixel region by using the estimated reference value of the black level, by a correction unit.

(20) An imaging apparatus includes an imaging element that includes an effective pixel region and an OPB region, which are constituted of a plurality of pixels of which periods of charge accumulation time are different from each other, and images a subject, an acquisition unit configured to acquire signal values of the plurality of pixels of which the periods of charge accumulation time in the OPB region are different from each other, and an estimation unit configured to estimate a reference value of a black level which is used for correcting a black level of a signal value of a pixel signal of the effective pixel region, by using the signal values, which are acquired by the acquisition unit, of the plurality of pixels of which the periods of the charge accumulation time are different from each other.

The present disclosure contains subject matter related to that disclosed in Japanese Priority Patent Application JP 2011-216201 filed in the Japan Patent Office on Sep. 30, 2011, the entire contents of which are hereby incorporated by reference.

What is claimed is:

1. An image processing apparatus, comprising:
a calculation unit configured to calculate a parameter indicating a degree of change of a difference value between signal values of pixel signals of different pixels in an OPB region of an imaging element; and
an estimation unit configured to estimate a reference value of a black level, the reference value being used for correcting a black level of a signal value of a pixel signal in an effective pixel region of the imaging element, by using a model of the parameter that is calculated by the calculation unit.

2. The image processing apparatus according to claim 1, further comprising:
a storage unit configured to store the model of the parameter; wherein
the estimation unit estimates the reference value of the black level by using the model that is stored in the storage unit.

3. The image processing apparatus according to claim 2, further comprising:
a generation unit configured to generate a model of the parameter; wherein
the storage unit stores the model of the parameter, the model being generated by the generation unit.

4. The image processing apparatus according to claim 3, wherein
the generation unit generates the parameter for every predetermined condition, and
the storage unit stores the model of the parameter for the every condition, the model being generated by the generation unit.

5. The image processing apparatus according to claim 2, further comprising:
a specifying unit configured to specify a model closest to the parameter that is calculated by the calculation unit, from the model that is stored in the storage unit; wherein
the estimation unit estimates a reference value of the black level by using the model that is specified by the specifying unit.

6. The image processing apparatus according to claim 1, further comprising:
a detection unit that compares a signal value of a pixel signal of the OPB region or a difference value between pixels, of which signal values are different from each other, with a threshold value so as to detect light leakage into the OPB region; wherein
the estimation unit estimates a reference value of the black level only in a case where the light leakage is detected by the detection unit.

7. The image processing apparatus according to claim 1, further comprising:
a correction unit configured to correct a black level of a signal value of a pixel signal in the effective pixel region of the imaging element, by using the reference value of the black level, the reference value being estimated by the estimation unit.

8. The image processing apparatus according to claim 1, wherein the parameter is a change rate or a change amount of the difference value for every distance to the effective pixel region.

9. The image processing apparatus according to claim 1, wherein
the imaging element has a multi-layer configuration, and
the calculation unit and the estimation unit are provided on a layer on which the OPB region and the effective pixel region are not formed, in the multi-layer configuration.

10. The image processing apparatus according to claim 1, wherein
the imaging element has a vertical light dispersion configuration by which a plurality of color signals are detected in each pixel,
the calculation unit calculates the parameter for each of the color signals, and
the estimation unit estimates a reference value of the black level for each of the color signals.

11. The image processing apparatus according to claim 1, wherein
the imaging element detects infrared light,
the calculation unit calculates a parameter indicating a degree of change of a difference value between signal values of pixel signals of infrared light of different pixels in the OPB region of the imaging element, and
the estimation unit estimates a reference value of a black level, the reference value being used for correcting a black level of a signal value of a pixel signal of infrared light in an effective pixel region of the imaging element, by using a model of the parameter that is calculated by the calculation unit.

12. A correcting method for correcting a black level of a signal value of a pixel signal in an effective pixel region of an imaging element, comprising:
calculating a parameter indicating a degree of change of a difference value between signal values of pixel signals of different pixels in an OPB region of the imaging element, by a calculation unit;
estimating a reference value of a black level, the reference value being used for correcting a black level of a signal value of a pixel signal in the effective pixel region by using a model of the calculated parameter, by an estimation unit; and
correcting a black level of a signal value of a pixel signal of the effective pixel region by using the estimated reference value of the black level, by a correction unit.

13. An imaging apparatus, comprising:
an imaging element that includes an effective pixel region and an OPB region and images a subject;
a calculation unit configured to calculate a parameter indicating a degree of change of a difference value between signal values of pixel signals of different pixels in the OPB region of the imaging element; and
an estimation unit configured to estimate a reference value of a black level, the reference value being used for correcting a black level of a signal value of a pixel signal in the effective pixel region of the imaging element, by using a model of the parameter that is calculated by the calculation unit.

14. An image processing apparatus, comprising:
an acquisition unit configured to acquire signal values of a plurality of pixels of which periods of charge accumulation time in the OPB region of an imaging element are different from each other; and
an estimation unit configured to estimate a reference value of a black level, the reference value being used for correcting a black level of a signal value of a pixel signal in an effective pixel region of the imaging element, by using the signal values, the signal values being acquired by the acquisition unit, of the plurality of pixels of which the period of the charge accumulation time are different from each other.

15. The image processing apparatus according to claim 14, wherein
the acquisition unit acquires a signal value of a short time accumulation pixel of which the charge accumulation time in the OPB region is relatively short and a signal value of a long time accumulation pixel of which the charge accumulation time in the OPB region is relatively long, and
the estimation unit estimates a reference value of the black level by using the signal value of the short time accumulation pixel and the signal value of the long time accumulation pixel, the signal values being acquired by the acquisition unit.

16. The image processing apparatus according to claim 15, wherein the estimation unit estimates a reference value of the black level by using a rate between accumulation time of the short time accumulation pixel and accumulation time of the long time accumulation pixel, the signal value of the short time accumulation pixel, and the signal value of the long time accumulation pixel.

17. The image processing apparatus according to claim 14, further comprising:
a detection unit that compares the signal value that is acquired by the acquisition unit or a difference value between the signal values of pixels of which periods of the accumulation time in the OPB region are same as each other with a threshold value so as to detect light leakage into the OPB region; wherein
the estimation unit estimates a reference value of the black level only in a case where the light leakage is detected by the detection unit.

18. The image processing apparatus according to claim 14, further comprising:
a correction unit configured to correct a black level of a signal value of a pixel signal in an effective pixel region of the imaging element, by using the reference value of the black level, the reference value being estimated by the estimation unit.

19. A correcting method for correcting a black level of a signal value of a pixel signal in an effective pixel region of an imaging element, comprising:
acquiring signal values of a plurality of pixels of which periods of charge accumulation time in the OPB region of the imaging element are different from each other, by an acquisition unit;
estimating a reference value of a black level, the reference value being used for correcting a black level of a signal value of a pixel signal in the effective pixel region, by using the acquired signal values of the plurality of pixels of which the periods of charge accumulation time are different from each other, by an estimation unit; and
correcting a black level of a signal value of a pixel signal in the effective pixel region by using the estimated reference value of the black level, by a correction unit.

20. An imaging apparatus, comprising:
an imaging element that includes an effective pixel region and an OPB region, the effective pixel region and the OPB region being constituted of a plurality of pixels of which periods of charge accumulation time are different from each other, and images a subject;
an acquisition unit configured to acquire signal values of the plurality of pixels of which the periods of charge accumulation time in the OPB region are different from each other; and
an estimation unit configured to estimate a reference value of a black level, the reference value being used for correcting a black level of a signal value of a pixel signal of the effective pixel region, by using the signal values, the signal values being acquired by the acquisition unit, of the plurality of pixels of which the periods of the charge accumulation time are different from each other.
